(19) United States
(12) Patent Application Publication
(10) Pub. No.: US 2013/0144425 A1
(43) Pub. Date: Jun. 6, 2013

(54) FIVE-AXIS FLANK MILLING SYSTEM FOR MACHINING CURVED SURFACE AND A TOOLPATH PLANNING METHOD THEREOF

(71) Applicants: Chih-Hsing Chu, Hsinchu City (TW); Hsin-Ta Hsieh, Hsinchu City (TW)

(72) Inventors: Chih-Hsing Chu, Hsinchu City (TW); Hsin-Ta Hsieh, Hsinchu City (TW)

(73) Assignee: NATIONAL TSING HUA UNIVERSITY, Hsinchu City (TW)

(21) Appl. No.: 13/493,352

(22) Filed: Jun. 11, 2012

(30) Foreign Application Priority Data
Nov. 28, 2011 (TW) 100143480

(51) Int. Cl. G06F 17/50

(52) U.S. Cl. 700/184

(57) ABSTRACT

The present invention discloses a five-axis flank milling system for machining a curved surface and a tool-path planning method. The method generates a tool path comprising a series of cutter locations by optimization with minimizing machining errors. The tool path planning method includes a reciprocating tool path planning method and a multi-pass tool path planning method. The reciprocating tool path planning method eliminates the “forward only” limitation. The tool is allowed to move backward in certain regions, producing smaller machining errors compared with forward only cutter movement. Furthermore, the multi-pass tool path planning method computes various tool paths applied to finish milling multiple times. Each path can be chosen to be generated by minimizing undercut error, overcut error, or the total machining error. The machining errors are reduced in a progressive manner, resulting in better machining quality than single pass tool path.

### PRIORITY CLAIM

This application claims the benefit of the filing date of Taiwan Patent Application No. 100143480, filed. Nov. 28, 2011, entitled “A FIVE-AXIS FLANK MILLING SYSTEM FOR MACHINING CURVED SURFACE AND A TOOLPATH PLANNING METHOD THEREOF,” and the contents of which is hereby incorporated by reference in its entirety.

### FIELD OF THE INVENTION

The present invention relates to a five-axis flank milling system for machining curved surface and a tool-path planning method thereof, and more specifically, the tool-path planning method of the present invention can minimize machining error by applying reciprocating tool motion and multi-pass tool path.

### BACKGROUND OF THE INVENTION

Five-axis machining is commonly used to produce complex geometries in automobile, aerospace, energy, and mold industries. With additional degrees of freedom in its tool motion, five-axis machining offers better shaping capability and productivity compared to three-axis machining. Tool path planning is a difficult task in most five-axis machining operations. Two major concerns are tool collision avoidance and machining error control.

Five-axis machining operations can be categorized into two types: end milling and flank milling. In flank milling, material removal mainly occurs on the tool flank through line contact with the cutting teeth. From a geometric perspective, to completely avoid machining error is not possible in five-axis flank milling when a cylindrical cutter is used to produce curved surfaces. The machined surface is considered acceptable in practice as long as the amount of machining error is limited within a given tolerance.

Five-axis flank milling is often applied to produce ruled surfaces. A simple method of tool path generation in this case is to let the cutter follow the ruling lines of the machined surface. This is the tool motion used most frequently in current industry, despite of its serious machining error produced on twisted surfaces.

Most prior art developed geometric algorithms that adjust individual cutter locations for reducing machining error. The adjustment of one cutter location is independent from the others. Such a greedy approach does not consider the machining errors generated between consecutive cutter locations, thus leading to sub-optimal solutions with a larger machining error, as disclosed in Taiwan patent application number 96147909. Therefore, the same patent developed a tool path planning method for five-axis flank milling of ruled surfaces based on global optimization methods. The developed method can precisely control the machining error produced on the machined surface through the optimization process with machining error minimization as the objective.

The tool path planning method mentioned above suffers from unsatisfactory quality of optimal solutions due to two assumptions. The first assumption is that the cutter must make contact with the boundary curves. Also, tool motion is designed for moving forward only. Both assumptions greatly restrict the solution space in search for optima, resulting in worse tool paths.

### SUMMARY OF THE INVENTION

Therefore, in order to overcome the deficiency mentioned above, a scope of the present invention is to provide a five-axis flank milling system for machining ruled surfaces. This system comprises an interface module, an arithmetic module, a machining module, and a control module.

The interface module reads the geometric definition of the workpiece to be machined on a workpiece. The machining module comprises a cutting tool for removing material from a given stock material. The control module is coupled with the arithmetic module and the machining module for controlling the machining module to produce the workpiece with the cutting tool according to the tool path generated. And the arithmetic module is coupled with the interface module for generating a tool path according to the surface geometry to be machined and the user commands.

However, the tool path of the present invention includes, but is not limited to, the description above in actual applications, the tool path comprises a first tool motion and a second tool motion. The first tool motion and the second tool motion are constructed with a first index and a second index respectively according to the surface geometry to be machined and the user commands. The first tool motion and the second tool motion have a first error value and a second error value respectively. In addition, the first tool motion and the second tool motion are used for removing the material of a first bulk and a second bulk from the stock material respectively. The first index and the second index are defined by the user commands.

Furthermore, another scope of the invention is to provide a tool path planning method for five-axis flank machining of curved surfaces. Material is removed from the stock by a cutting tool according to the tool path generated, following: step S11: preparing a curved surface; step S12: reading user commands; and step S13: generating the tool path based on the curved surface and the user commands. Wherein, the tool path comprises a first cutter location, a second cutter location, and a third cutter location, and the three cutter locations correspond to a first tool motion and a second moment, respectively, the first tool motion is ahead of the second tool motion.

Another scope of the invention is to provide a tool path planning method for five-axis flank machining of curved surfaces. The method comprises step S21 to step S24. The step S21 and S22 are similar with the step S11 and S12 mentioned above, thus the steps need not be elaborated any further. At step S23, constructing a first tool motion with a first index according to the curved surface and the user commands, wherein the first tool motion has a first error value; and step S24: constructing a second tool motion with a second index according to the curved surface and the user commands, wherein the second tool motion has a second error value. Moreover, the first index and the second index are corresponded to the user commands, the sequence of the first tool motion and the second tool motion is run independently of the summation of the first error value and the second error value.

In addition, the first tool motion and the second tool motion are used for removing material of a first bulk and a second bulk from the stock respectively, and the sequence of the first tool motion and the second tool motion is run independently of the summation of the first bulk and the second bulk.

In conclusion, the present invention discloses a five-axis flank machining system for curved surfaces and includes a tool-path planning method of reciprocating tool motion M1 and a multi-pass tool path planning method M2. By eliminating the “forward only” limitation of traditional tool-path planning methods, the present invention is able to move the cutting tool backward first; then resume forward, so as to produce a machined curved surface of a smaller error. Furthermore, the multi-pass tool path planning method M2 is able to minimize machining error by applying various tool paths on the stock progressively for multiple times, wherein each of the tool paths is generated in accordance with the same surface to be machined.

Many other advantages and features of the present invention will be manifested by further descriptions and the accompanying sheet of drawings.

### BRIEF DESCRIPTION OF THE DRAWINGS

FIG. 1 is a schematic diagram illustrating an initial tool path and the representative matrix thereof.

FIG. 2 is a flowchart illustrating a tool-path planning method of reciprocating tool motion of the invention.

FIG. 3A is a schematic diagram illustrating an initial tool path of the reciprocating tool path planning method according to an embodiment of the invention.

FIG. 3B is another schematic diagram illustrating an initial tool path of the reciprocating tool path planning method according to an embodiment of the invention.

FIG. 4A is a schematic diagram illustrating the first tool motion according to an embodiment of the reciprocating tool path planning method of the invention.

FIG. 4B is a schematic diagram illustrating the second tool motion according to an embodiment of the reciprocating tool path planning method of the invention.

FIG. 4C is a schematic diagram illustrating the tool path according to an embodiment of the reciprocating tool path planning method of the invention.

FIG. 5 is a flowchart illustrating a multi-pass tool path planning method according to an embodiment of the invention.

FIG. 6 is a function block diagram illustrating a five-axis flank milling system for machining curved surface according to an embodiment of the invention.

To facilitate understanding, identical reference numerals have been used, where possible to designate identical elements that are common to the figures.

### DETAILED DESCRIPTION

The invention discloses a five-axis flank milling system for machining curved surface and a tool path planning method thereof. The word “tool path” in the description is defined as the motion of cutting tool which consists of a series of cutter locations; the word “work-piece” is defined as the material to be machined; and the word “curved surface” means a desired surface machined from the work-piece. Besides, the five-axis flank milling system for machining curved surface and a tool path planning method thereof are represented as “machining system” and “planning method” respectively.

The planning method of the invention is utilized to generate a tool path for a cutting tool to remove material from a work-piece along the tool path according to the user input commands. Additionally, the present invention provides two methods to minimize machining errors, and the two methods are the tool-path planning method of reciprocating tool motion M1 and the multi-pass tool path planning method M2 respectively.

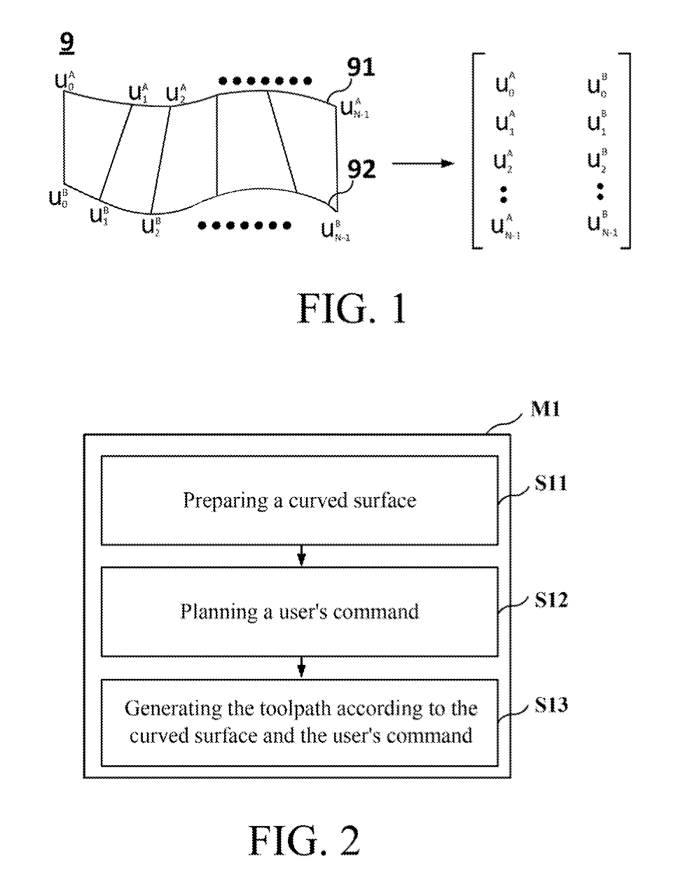

Please refer to FIG. 1. FIG. 1 is a schematic diagram illustrating the tool contact point of an initial tool path on the surface to be machined and the representative curve parameters thereof. As shown in FIG. 1, the initial tool path of convention 9 is formed by selecting points on the two boundary curves 91 and 92 respectively, determining the cutter center points of both tool ends by offsetting those points along the surface normal directions with a distance of tool radius, and then generating the tool axis by connecting the offset points. However, the tool contact points are restricted to the boundary curve 91 and 92. The tool motion is forwarding only. Thus the optimized tool path of convention 9 cannot result in minimal machining errors due to a smaller restricted solution space.

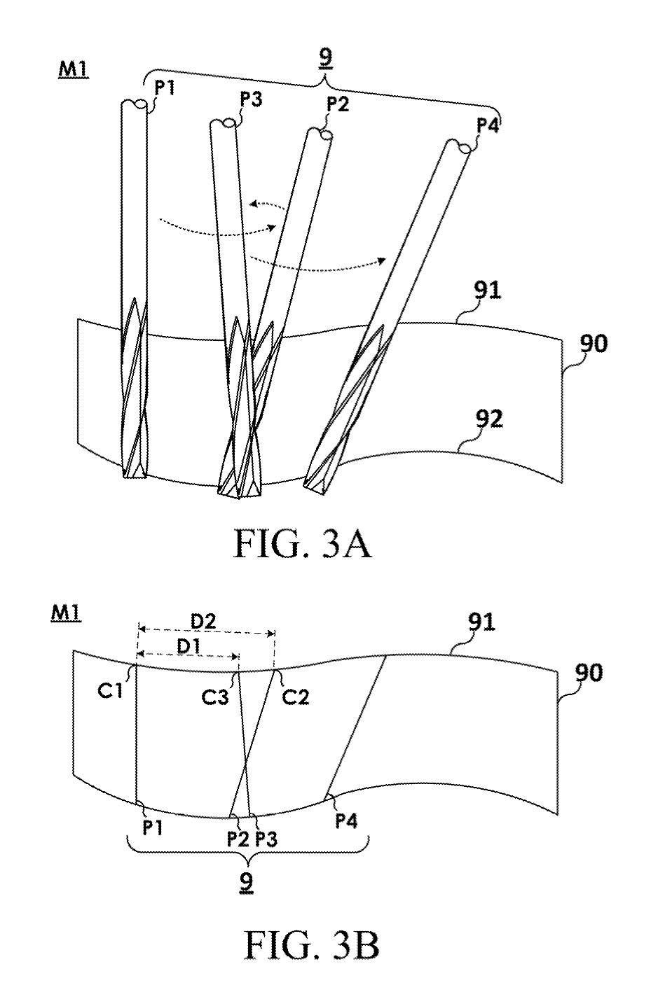

Therefore, the present invention provides a reciprocating tool path planning method M1 to solve the problem mentioned above. More specifically, please refer to FIG. 1, FIG. 2, FIG. 3A, and FIG. 3B. FIG. 2 is a flowchart illustrating a reciprocating tool path planning method of the invention. FIG. 3A and FIG. 3B are the schematic diagrams illustrating an initial tool path of the reciprocating tool path planning method according to an embodiment of the invention respectively. As show in the figures, the reciprocating tool path planning method M1 comprises step S11, S12, and S13.

Step S11 is to prepare a curved surface to be machined. More specifically, at step S11, a three-dimensional surface is obtained from a data source or by other methods. Step S12 is to read user commands, wherein the commands comprises an overcut error minimization command, an undercut error minimization command, or a total error minimization command, the number of cutter locations, the density of linear interpolation, and other parameters for computing the tool path.

And step S13 is to generate an initial tool path 9 according to the curved surface and the user command. In order to illustrate the difference between the present invention and the prior art, please refer to FIG. 1 again. The initial tool path 9 is determined by points on the two boundary curves 91 and 92. On the initial tool-path 9 of prior art, the points u₀^{A} to uₙ₋₁^{A} and u₀^{B} to uₙ₋₁^{B} on the two boundary curves 91 and 92 of the curved surface 90 should be corresponded and arranged in order from least to greatest, so that the cutting tool can program a forward-only tool-path.

Compared to the prior art, the present invention breaks the restriction of the points. More specifically, the points u₀^{A} to uₙ₋₁^{A} and u₀^{B} to uₙ₋₁^{B} on the initial tool path 9 must be arranged in a ascending order in the corresponding curve parameters. The situations of uᵢ^{A}>uᵢ₊₁^{A} or uᵢ^{B}>uᵢ₊₁^{B} is allowed in computing the initial tool path of present invention, more specifically, the i+2 cutter location can be positioned between the and the i and the i+1 cutter locations, so as to make the tool motion partly backward. Therefore, the tool path planning method can move the tool backward and then resume moving forward in some regions were machining error can be reduced compared to forwarding only tool motion.

In order to illustrate the relative relation of each cutter location in a reciprocating tool path plan, please refers to FIG. 3A and. FIG. 3B. As shown in the figures, the initial tool path 9 comprises a first cutter location P1, a second cutter location P2, a third cutter location P3, and a fourth cutter location P4. The four cutter locations are corresponded to a first tool motion, a second motion, and a third motion, respectively.

Wherein, the first tool motion is ahead of the second tool motion, the second tool motion is ahead of the third tool motion. Three cutter locations P1, P2, P3 and the above boundary curve 91 (or called first curve) are assigned with a first coordinate C1, a second coordinate C2, and a third coordinate C3 respectively, meanwhile, the curve length D2 between the first coordinate C1 and the second coordinate C2 is greater than the curve length D1 between the first coordinate C1 and the third coordinate C3.

After encoding the cutter locations described above, evolutionary optimization methods (genetic algorithm, particle swarm optimization, ant colony optimization, and/or simulated annealing) can be applied to compute a reciprocating tool path. The total error on the machined surface serves as an objective in the optimization process, which searches for an optimal tool path with an initial tool path 9.

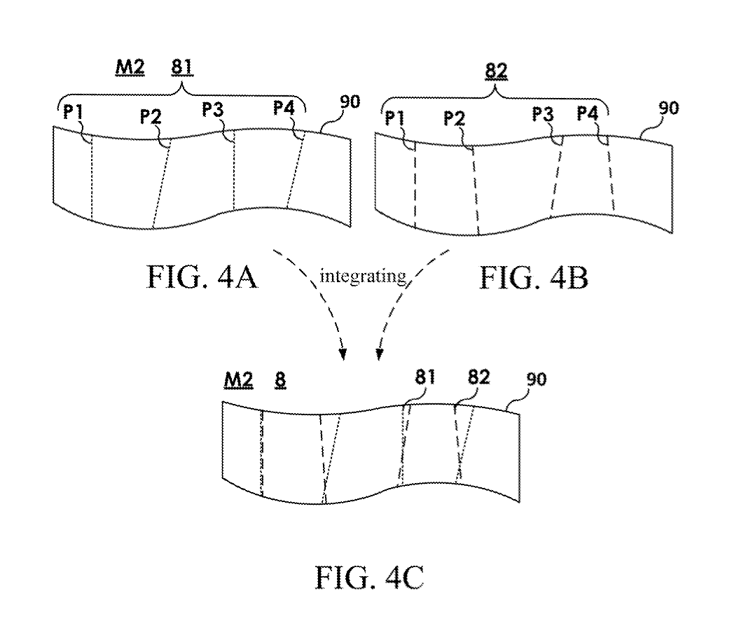

In addition, the present invention further provides a multi-pass tool planning method M2 for improving the effectiveness of machining system. The multi-pass tool planning method M2 is utilized to generate a tool path 8 for a cutting tool to remove material from a work-piece along the tool-path 8.

Wherein, the tool path 8 comprises at least a first path 81 and a second path 82. Please refer to FIG. 4A to 4C, FIG. 4A is a schematic diagram illustrating the first path according to an embodiment of the invention; FIG. 4B is a schematic diagram illustrating the second path according to an embodiment of the invention; and FIG. 4C is a schematic diagram illustrating the tool path according to an embodiment of the invention.

More specifically, the multi-pass tool planning method M2 computes several passes of tool path that constitutes a complete tool path with different indexes, so as to minimize the errors of curved surface 90 by machining in a progressive manner. To be noticed, each pass of tool path is constructed with a corresponding index. And the several passes of tool path comprises a first path 81 and a second path 82, these two paths represent a tool path in a corresponding machining process. Either overcut error, undercut error, or the total error of the machined surface can be chosen as the objective in each machining process with the tool path planning method of the present invention.

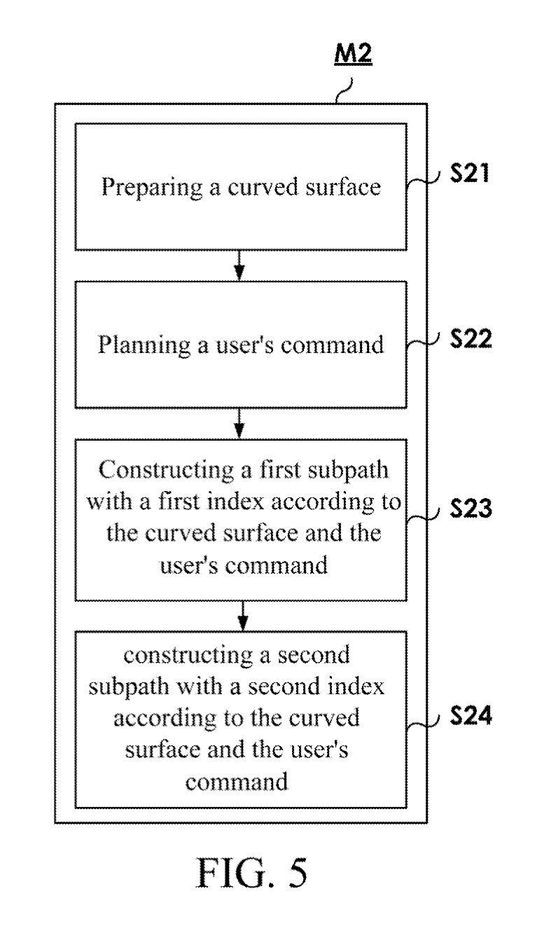

FIG. 5 is a flowchart illustrating the multi-pass tool planning method according to an embodiment of the invention. As shown in FIG. 5, the multi-pass tool planning M2 comprises steps S21 to S24, wherein the steps S2 land S22 are in essence the same as the steps S11 and S12 of the reciprocating tool path planning method M1, thus the steps need not be elaborated any further.

Step S23 is to construct a first pass of tool path 81 with a first index according to the surface 90 and the user commands, wherein the path 81 produces a first error value; and S24 is to construct a second pass of tool path 82 with a second index according to the surface 90 and the user commands, wherein the path 82 produces a second error value.

For example, overcut error minimization and undercut error minimization are chosen to be the objectives in the first index and the second index respectively. The first pass of tool path 81 comprises cutter locations generated by using overcut error minimization command; and the second pass of tool path 82 comprises cutter locations by using undercut error minimization command. In the tool path optimization process, the search priority is to eliminate overcut error and undercut error, respectively.

The amount and distribution of stock material left on the workpiece are different after each machining process. Thus, the workpiece geometry from which the tool path is computed is different from the first pass of tool path 81 and the second pass of tool path 82, although the reference surface is the same curved surfaces 90.

The machining process of prior art usually adopts rough milling first and then finish milling. This machining strategy is to maximize the machining productivity in the rough milling and to achieve quality surface finish in the finish milling with different tools and machining parameters. Tool path planning of the rough milling is normally based on the offset geometry of the surface to be machined while the finish milling is based on the surface to be machined. Uniform material is expected to remain on the workpiece after the rough milling and to be removed by finish milling. A major difference between the prior art and the present invention is that the multiple passes of tool path generated by the planning method of the present invention are all applied in finish milling. The successive tool paths are calculated to reduce machining error in a progressive manner.

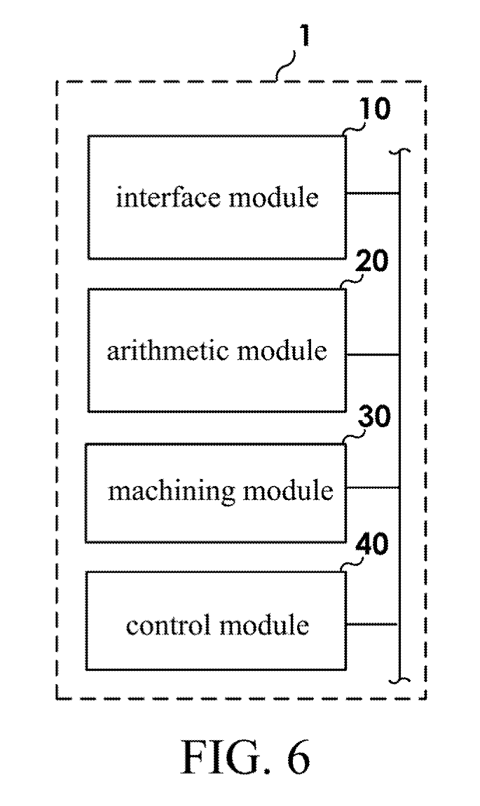

The present invention also discloses a five-axis flank milling system for machining curved surfaces with the reciprocating tool path planning method M1 and the multi-pass tool path planning method M2 described previously. The system guides a cutting tool to remove material from a work-piece along the tool path generated by the two methods. The resultant tool path produces a smaller error on the machined surface compared to the tool paths generated by prior art. FIG. 6 is a function block diagram illustrating a five-axis flank milling system for machining curved surface according to an embodiment of the invention. Wherein, the system 1 comprised an interface module 10, an arithmetic module 20, a machining module 30, and a control module 40.

The interface module 10 inputs the geometric definition of the surface to be machined and user commands; wherein the curved surface and the commands have been described previously. The arithmetic module 20 is coupled with the interface module 10 for computing tool path based on reciprocating tool path planning method M1 and the multi-pass tool path planning method M2. And the control module 40 is coupled with both the arithmetic module 20 and the machining module 30 for machining the work-piece according to the tool path computed. In actual applications, the system 1 described above can be a five-axis machine tool connected with a computer.

The reciprocating tool path planning method M1 eliminates the “forward only” limitation of traditional tool path planning methods. The cutting tool can move forward first; then partially backward and resume moving forward in some regions on the surface to be machined as long as such reciprocating tool motion further reduce machining errors. The multi-pass tool path planning method M2 computes several passes of tool path that constitutes a complete tool path with different indexes, so as to minimize machining errors in a progressive manner.

The above disclosure should be construed as limited only by the metes and bounds of the appended claims.

1. A five-axis flank milling system for machining a curved surface by computing a tool path for guiding a cutting tool to remove stock material from a work-piece, the system comprising:
an interface module for inputting a geometric definition of the curved surface to be machined and user commands; and
an arithmetic module coupled with the interface module for generating a tool path based on the curved surface and the user commands.

2. The five-axis flank milling system of claim 1,
wherein the tool path comprises a first tool motion and a second tool motion, the first tool motion and the second tool motion are constructed with a first index and a second index respectively according to the surface geometry to be machined and the user commands, the first tool motion and the second tool motion have a first error value and a second error value respectively, the first tool motion and the second tool motion are used for removing the material of a first bulk and a second bulk from the stock material respectively, the first index and the second index are defined by the user commands.

3. The five-axis flank milling system of claim 1, further comprising:
a machining module guiding the cutting tool for removing material from the work-piece; and
a control module coupled with the arithmetic module and the machining module for machining the work-piece by using the cutting tool with the tool path generated by the arithmetic module.

4. A tool path planning method of a five-axis flank milling system for machining a curved surface from a work-piece, the method comprising:
S11: preparing the curved surface;
S12: inputting user commands; and
S13: generating a tool path based on the curved surface and the user commands;
wherein the tool path comprises a first cutter location, a second cutter location, and a third cutter location, the three cutter locations correspond to a first tool motion and a second moment respectively, the first tool motion is ahead of the second tool motion, the three cutter locations are assigned with a first coordinate, a second coordinate, and a third coordinate respectively, a curve length on the boundary between the first coordinate and the second coordinate is greater than a curve length between the first coordinate and the third coordinate.

5. The tool path planning method of claim 4, further comprising:
S23: constructing a first pass of the tool path with a first index according to the curved surface and the user commands, wherein the first pass of the tool path produces a first error value; and
S24: constructing a second pass of the tool path with a second index according to the curved surface and the user commands, wherein the second pass of the tool path produces a second error value;
wherein the first index and the second index are defined by the user commands, the sequence of the first pass of the tool path and the second pass of tool path is run independently of the summation of the first error value and the second error value.

6. A tool path planning method of a five-axis flank milling system for machining a curved surface from a work-piece, the method comprising:
S31: preparing the curved surface;
S32: inputting user's commands;
S33: constructing a first pass of the tool path with a first index according to the curved surface and the user commands, wherein the first pass of tool path removes material of a first bulk from the work-piece; and
S34: constructing a second pass of tool path with a second index according to the curved surface and the user commands, wherein the second pass of tool path removes material of a second bulk from the work-piece;
wherein the first index and the second index are corresponded to the user commands, the sequence of the first pass of tool path and the second pass of tool path is run independently of the summation of the first bulk and the second bulk.

7. The tool path planning method of claim 4, wherein the user commands comprise an overcut error minimization command, an undercut error minimization command, or a total error minimization command.
